(19) United States
(12) Patent Application Publication
(10) Pub. No.: US 2016/0017264 A1
(43) Pub. Date: Jan. 21, 2016

(54) FLEXIBLE WATER-SOLUBLE ARTICLES

(71) Applicant: The Procter & Gamble Company, Cincinnati, OH (US)

(72) Inventors: David Xavante CUMMING, Strombeek-Bever (BE); Miguel BRANDT SANZ, Tervuren (BE); Atef Mohammed Bahay Eldin HAIKAL, Strombeek-Bever (BE); Andrew John FAGG, Strombeek-Bever (BE)

(21) Appl. No.: 14/802,084

(22) Filed: Jul. 17, 2015

(30) Foreign Application Priority Data
Jul. 21, 2014 (EP) 14177799.5

(51) Int. Cl. C11D 17/04; B65D 85/00; B65D 75/58

(52) U.S. Cl. CPC C11D 17/043; C11D 17/044; C11D 17/045; C11D 17/046; B65D 75/58; B65D 85/70; B65D 2575/586

(57) ABSTRACT

Cleaning products comprising flexible water-soluble articles and flexible water-insoluble films.

### FIELD OF THE INVENTION

The present invention relates to cleaning products comprising flexible water-soluble articles and flexible water-insoluble films.

### BACKGROUND OF THE INVENTION

Flexible water-soluble articles comprising cleaning compositions have become very popular with consumers. Such articles contain the cleaning composition which is only released once the article is contacted with water. This offers a convenient means for the consumer to dose the detergent into the water without the need of scoops or other measuring means.

However, an issue with such articles is that because they are water-soluble, they can rupture prematurely when they accidentally come into contact with water during storage. Such contact could include consumers accidentally touched an article with wet hands when retrieving a neighbouring article in a packaging tub or bag, or due to contact with moisture in the air during storage. Furthermore, due to the flexible nature of such articles, rupture can occur during storage due to external forces applying too much pressure onto the article.

Rupturing of articles can be messy and inconvenient for the consumer and can cause contamination of neighbouring articles, with internal compositional material and/or film material.

Therefore, there is a need in the art for a flexible water-soluble cleaning article which minimises incidents of rupturing, yet still maintains the convenience of the article for consumers.

It was surprisingly found that a cleaning product comprising an external water-insoluble film overcame this problem.

### SUMMARY OF THE INVENTION

A first aspect of the present invention is a cleaning product comprising;
a. An external flexible water-insoluble film defining an internal chamber;
b. At least one flexible water-soluble article contained within the internal chamber, wherein the article comprises a cleaning composition;
   wherein, the volume of the internal chamber is no greater than 15% larger than the volume of the article.

A second aspect of the present invention is to a process for making a packaged product according to the present invention, comprising the step of packaging the article in the external film via horizontal flow wrapping, vertical form fill sealing, horizontal form fill sealing or a combination thereof.

A third aspect of the present invention is a package comprising at least one product according to the present invention, wherein the package is rigid, flexible, or a combination thereof and comprises a resealable opening.

### BRIEF DESCRIPTION OF THE DRAWINGS

FIG. 1 shows a cross-section view of a cleaning product according to the present disclosure.

FIG. 2 shows a cleaning product according to the present disclosure.

FIG. 3 shows a cleaning product according to the present disclosure.

FIG. 4 shows a cleaning product according to the present disclosure.

FIG. 5 shows a flexible water-soluble article according to the present disclosure.

### DETAILED DESCRIPTION OF THE INVENTION

### Cleaning Product

The cleaning product 10 of the present invention comprises an external flexible water-insoluble film and at least one flexible water-soluble article. By ‘flexible’ we herein mean non-rigid. In other words, the external film or article are pliable when handled by a user such that the shape can at least be temporarily altered when a low level of mechanical pressure is exerted by the user. This is opposed to a rigid object wherein a high level of mechanical pressure is required to alter the shape, and such alternation would not necessarily be temporary.

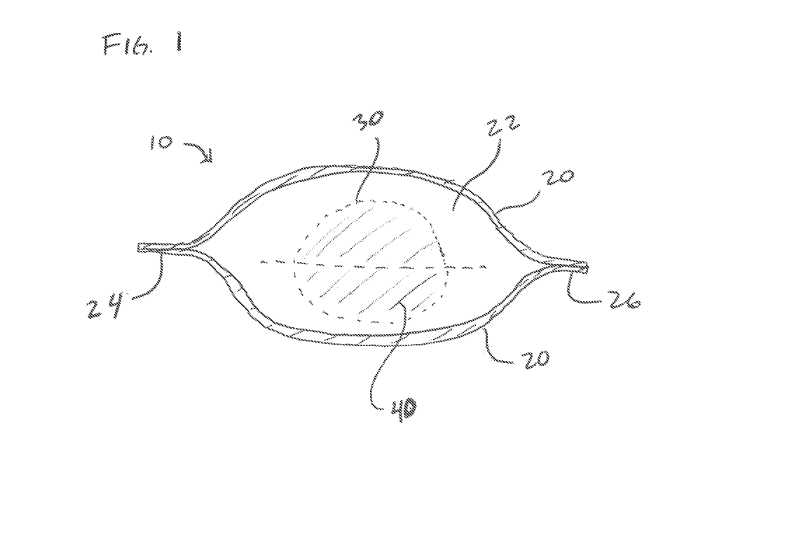

As shown as a cross-sectional view in FIG. 1, the external flexible water-insoluble film 30 defines an internal chamber 22 of the cleaning product 10. The at least one flexible water-soluble article 30 is contained within the internal chamber 22.

The internal chamber 22 has a volume, and the flexible water-soluble article has a volume, and the volume of the internal chamber is no greater than 15% larger than the volume of the article. The internal chamber may be no greater than 12%, or even 10% or even 8%, or even 5% larger than the volume of the article.

Alternatively, the external water-insoluble film 20 defines an internal chamber 22 of the cleaning product, wherein at least two, or even three, or even four articles 30 are contained within the internal chamber, and the volume of the internal chamber is no greater than 15%, or even 12%, or even 10%, or even 8%, or even 5% larger than the volume of the articles.

Preferably, the flexible external film 20 is sealed such that the flexible water-soluble article 30 cannot be removed from the internal chamber 22 without rupturing the external film 20.

The cleaning product 10 may have any suitable shape. The cleaning product 10 may have a square, rectangular, circular, superelliptical or oval shape.

### External Flexible Water-Insoluble Film

The external flexible film 20 can be any suitable film providing it is water-insoluble. The external flexible film 20 may be in the form of a continuous uninterrupted sheet of material. The external flexible film 20 may comprise holes or gaps. Where the external flexible film comprises holes or gaps, these may be present unintentionally, for example as minor imperfections in the film material. Alternatively, the holes or gaps may be present intentionally, for example the external flexible film is in the form of a net or a web.

The external flexible film 20 may be made from non-woven materials, woven materials or mixtures thereof.

The external flexible film 20 may be made from man-made materials, naturally-derived materials or a combination thereof. The film may be made of a plastic material, a metallic material or a combination thereof. The film may comprise a single layer, or may be laminated in which it comprises at least two layers. The layers may be made from the same or different materials.

The external flexible film 20 may comprise polyethylene, polypropylene, polyethylene terephthalate, aliphatic polyamides (also known as nylon), aluminium, paper or a combination thereof.

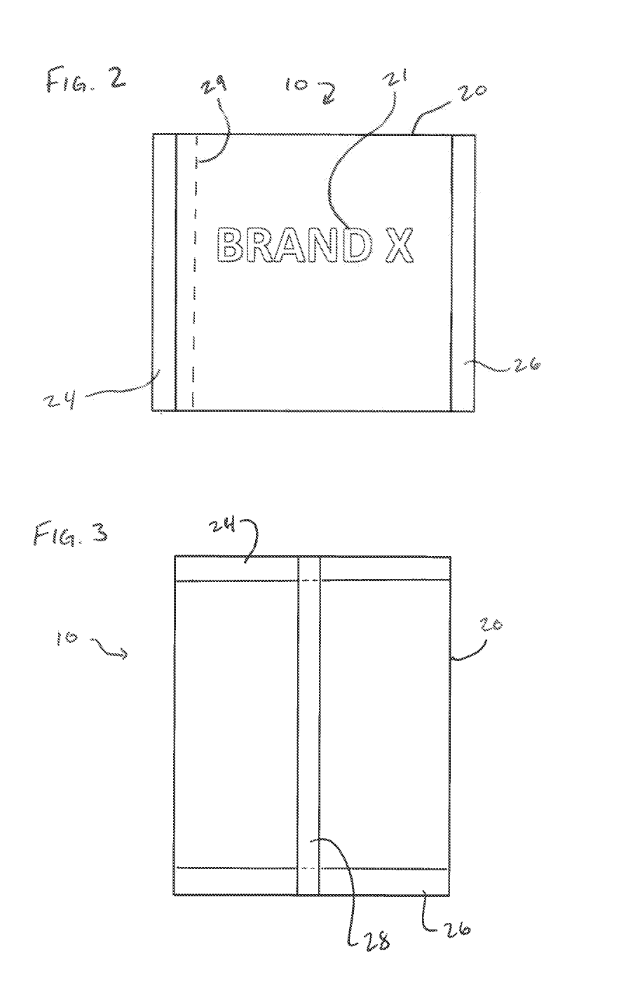

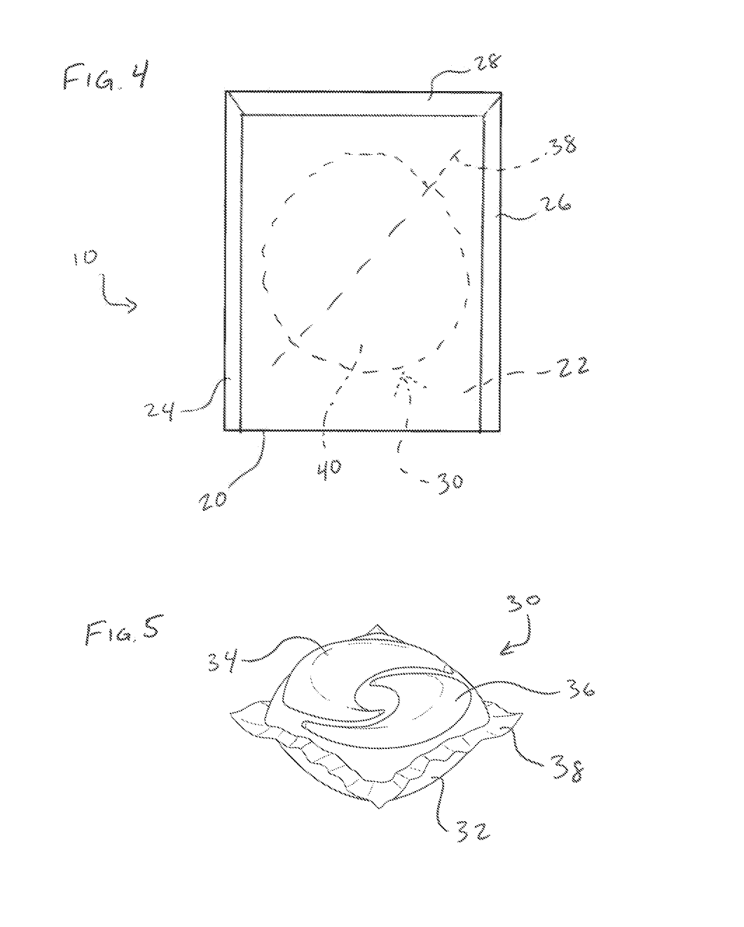

Preferably, the flexible external film 20 is sealed such that the flexible water-soluble article 30 cannot be removed from the internal chamber 22 without rupturing the external film 20. The external flexible film 20 may be sealed via heat sealing, pressure sealing, adhesive, heat activated adhesive, pressure activated adhesive, ultrasonic sealing or a combination thereof. The external flexible film 20 could be sealed in such a way that the cleaning product 10 comprises only one seal, or at least two seals, or even at least three seals 24, 26, 28. The flexible external film 20 could be shaped such that the cleaning product 10 comprises two seals 24, 26 orientated at opposite ends of the product, as shown in FIG. 2. Alternatively, it could be shaped such that the product comprises one seal running along the length of the product. Alternatively, as shown in FIG. 3 and FIG. 4 the film 20 could be shaped such that the product 10 comprises three seals in which one seal 28 runs the length of the product 10 and there are two further seals 24, 26 orientated at opposite ends of the product.

As shown in FIG. 2, the external flexible film may comprise means 29 to assist in opening. For example, it may comprise a ‘tear strip’, perforated lines, areas of weakness or a mixture thereof.

The external flexible water-insoluble film 20 may be opaque, translucent or transparent. The external film may comprise an area of print 21, as shown in FIG. 2. The area of print 21 may be applied via standard printing techniques such as flexographic printing or laser printing. The print may comprise a dye, an ink, a paint of a mixture thereof. The area of print 21 may be comprised on the outside of the film or may be comprised at least partially within the film, or a combination thereof. The print may be purely aesthetic or may provide useful information such as instructions for opening said external flexible film and/or instructions of use during a wash operation.

Alternatively, the film may comprise a colour agent added during manufacture such that at least part of the film is coloured.

### Flexible Water-Soluble Article

The flexible water-soluble article 30 comprises a cleaning composition 40. Upon addition to water, the water-soluble article 30 dissolves releasing the composition into the wash liquor. The water-soluble article 30 can be of any form, shape and material which is suitable for holding the composition, i.e. without allowing the release of the composition, and any additional component, from the article prior to contact of the article with water. The exact execution will depend, for example, on the type and amount of the compositions in the unit dose article. The unit dose article 30 may have a substantially, square, rectangular, oval, elliptoid, superelliptical, or circular shape. The shape may or may not include any excess material present as a flange or skirt at the point where two or more films are sealed together. By substantially, we herein mean that the shape has an overall impression of being for example square. It may have rounded corners and/or non-straight sides, but overall it gives the impression of being square for example.

The water-soluble unit dose article may comprise a water-soluble film 38. In such an execution, the water-soluble film 38 would preferably define an internal compartment wherein the cleaning composition is contained within said compartment. Preferably, the water-soluble article comprises at least two water-soluble films and at least one internal compartment, wherein the compartment is enclosed by the films and has an internal space and wherein the compartment comprises the cleaning composition within the internal space.

The unit dose article has a height, a width and a length. The maximum of any of these dimensions is meant to mean the greatest distance between two points on opposite sides of the unit dose article. In other words, the unit dose article may not have straight sides and so may have variable lengths, widths and heights depending on where the measurement is taken. Therefore, the maximum should be measured at any two points that are the furthest apart from each other.

The maximum length is between 2 cm and 8 cm, or even between 3 cm and 7 cm, or even between 3.5 cm and 7 cm.

The maximum width is between 2 cm and 8 cm, or even between 3 cm and 7 cm.

The maximum height is between 1 cm and 5 cm or even between 2 cm and 4.5 cm.

The length: height ratio may be from 3:1 to 1:1; or the width: height ratio is from 3:1 to 1:1, or even 2.5:1 to 1:1; or the ratio of length to height is from 3:1 to 1:1 and the ratio of width to height is from 3:1 to 1:1, or even 2.5:1 to 1:1, or a combination thereof.

The volume of the article maybe between 10 and 40 ml, or even between 10 and 35 ml, or even between 10 and 30 ml.

The article may have a weight of less than 35 g, or even between 10 g and 33 g, or even between 10 g and 30 g. The unit dose article may have a weight of between 10 g and 31 g, or even between 15 g and 30 g.

The article may comprise a gas, and wherein the ratio of the volume of said gas to the volume of the cleaning composition is between 1:4 and 1:20, or even between 1:5 and 1:15, or even between 1:5 and 1:9. Alternatively, the ratio of the volume of said gas to the volume of the cleaning composition is between 1:25 and 1:10, or even between 1:20 and 15:1 The water-soluble unit dose article comprises multiple compartments. The unit dose article may comprise two, or three, or four or five compartments.

A multi-compartment article form may be desirable for such reasons as separating chemically incompatible ingredients; or where it is desirable for a portion of the ingredients to be released into the wash earlier or later. The article 30 may comprise at least two, or even at least three, or even at least four, or even at least five compartments. The multiple compartments may be arranged in any suitable orientation. For example the article 30 may comprise a bottom compartment, and at least a first top compartment, wherein the top compartment is superposed onto the bottom compartment. As shown in FIG. 5, the article 30 may comprise a bottom compartment 32 and at least a first and a second top compartment 34, 36, wherein the top compartments 34, 36 are arranged side-by-side and are superposed on the bottom compartment 32; preferably, wherein the article comprises a bottom compartment and at least a first, a second and a third top compartment, wherein the top compartments are arranged side-by-side and are superposed on the bottom compartment.

The ratio of the surface area to volume ratio of the combined top compartments to the surface area to volume ratio of bottom compartment may be between 1:1.25 and 1:2.25, or even between 1:1.5 and 1:2. In this context the surface area is that which is in contact with the external environment only, and not that which is in contact with a neighbouring compartment. Alternatively, the ratio of the surface area to volume ratio of the combined top compartments to the surface area to volume ratio of bottom compartment may be between 1:1 and 3:1 or even between 1.5:1 and 2:1. In this context the surface area is that which is in contact with the external environment only, and not that which is in contact with a neighbouring compartment.

Alternatively, the compartments may all be positioned in a side-by-side arrangement. In such an arrangement the compartments may be connected to one another and share a dividing wall, or may be substantially separated and simply held together by a connector or bridge. Alternatively, the compartments may be arranged in a ‘tyre and rim’ orientation, i.e. a first compartment is positioned next to a second compartment, but the first compartment at least partially surrounds the second compartment, but does not completely enclose the second compartment.

Preferably, the article ruptures between 10 seconds and 5 minutes once the unit dose article has been added to 950 ml of deionised water at 20-21° C. in a 1 L beaker, wherein the water is stirred at 350 rpm with a 5 cm magnetic stirrer bar. By rupture, we herein mean the film is seen to visibly break or split. Shortly after the film breaks or splits the internal liquid detergent composition may be seen to exit the article into the surrounding water.

The article may be opaque, transparent or translucent. The article may comprise a printed area. The printed area may cover between 10 and 80% of the surface of the article.

The area of print may cover an uninterrupted portion of the article or it may cover parts thereof, i.e. comprise smaller areas of print, the sum of which represents between 10 and 80% of the surface of the article.

The area of print may comprise inks, pigments, dyes, blueing agents or mixtures thereof. The area of print may be opaque, translucent or transparent.

The area of print may comprise a single colour or maybe comprise multiple colours, even three colours. The area of print may comprise white, black, blue, red colours, or a mixture thereof. The print may be present as a layer on the surface of the article or may at least partially penetrate into the article.

The area of print may comprise an ink, wherein the ink comprises a pigment. The ink for printing onto the article has preferably a desired dispersion grade in water. The ink may be of any color including white, red, and black. The ink may be a water-based ink comprising from 10% to 80% or from 20% to 60% or from 25% to 45% per weight of water. The ink may comprise from 20% to 90% or from 40% to 80% or from 50% to 75% per weight of solid.

The ink may have a viscosity measured at 20° C. with a shear rate of 1000s⁻¹ between 1 and 600 cPs or between 50 and 350 cPs or between 100 and 300 cPs or between 150 and 250 cPs. The measurement may be obtained with a cone-plate geometry on a TA instruments AR-550 Rheometer.

The area of print may be achieved using standard techniques, such as flexographic printing or inkjet printing. Alternatively, an ink or pigment may be added during the manufacture of the article such that all or at least part of the article is coloured.

### Water-Soluble Film

The film 38 of the article is soluble or dispersible in water, and preferably has a water-solubility of at least 50%, preferably at least 75% or even at least 95%, as measured by the method set out here after using a glass-filter with a maximum pore size of 20 microns:

50 grams±0.1 gram of film material is added in a pre-weighed 400 ml beaker and 245 ml±1 ml of distilled water is added. This is stirred vigorously on a magnetic stirrer set at 600 rpm, for 30 minutes. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

Preferred film materials are preferably polymeric materials. The film material can, for example, be obtained by casting, blow-moulding, extrusion or blown extrusion of the polymeric material, as known in the art.

Preferred polymers, copolymers or derivatives thereof suitable for use as pouch material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the pouch material, for example a PVA polymer, is at least 60%. The polymer can have any weight average molecular weight, preferably from about 1000 to 1,000,000, more preferably from about 10,000 to 300,000 yet more preferably from about 20,000 to 150,000.

Mixtures of polymers can also be used as the film material. This can be beneficial to control the mechanical and/or dissolution properties of the compartments or pouch, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000-40,000, preferably around 20,000, and of PVA or copolymer thereof, with a weight average molecular weight of about 100,000 to 300,000, preferably around 150,000. Also suitable herein are polymer blend compositions, for example comprising hydrolytically degradable and water-soluble polymer blends such as polylactide and polyvinyl alcohol, obtained by mixing polylactide and polyvinyl alcohol, typically comprising about 1-35% by weight polylactide and about 65% to 99% by weight polyvinyl alcohol. Preferred for use herein are polymers which are from about 60% to about 98% hydrolysed, preferably about 80% to about 90% hydrolysed, to improve the dissolution characteristics of the material.

Preferred film materials are polymeric materials. The film material can be obtained, for example, by casting, blow-moulding, extrusion or blown extrusion of the polymeric material, as known in the art. Preferred polymers, copolymers or derivatives thereof suitable for use as pouch material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the pouch material, for example a PVA polymer, is at least 60%. The polymer can have any weight average molecular weight, preferably from about 1000 to 1,000,000, more preferably from about 10,000 to 300,000 yet more preferably from about 20,000 to 150,000. Mixtures of polymers can also be used as the pouch material. This can be beneficial to control the mechanical and/or dissolution properties of the compartments or pouch, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000-40,000, preferably around 20,000, and of PVA or copolymer thereof, with a weight average molecular weight of about 100,000 to 300,000, preferably around 150,000. Also suitable herein are polymer blend compositions, for example comprising hydrolytically degradable and water-soluble polymer blends such as polylactide and polyvinyl alcohol, obtained by mixing polylactide and polyvinyl alcohol, typically comprising about 1-35% by weight polylactide and about 65% to 99% by weight polyvinyl alcohol. Preferred for use herein are polymers which are from about 60% to about 98% hydrolysed, preferably about 80% to about 90% hydrolysed, to improve the dissolution characteristics of the material. Preferred films exhibit good dissolution in cold water, meaning unheated water straight from the tap. Preferably such films exhibit good dissolution at temperatures below 25° C., more preferably below 21° C., more preferably below 15° C. By good dissolution it is meant that the film exhibits water-solubility of at least 50%, preferably at least 75% or even at least 95%, as measured by the method set out here after using a glass-filter with a maximum pore size of 20 microns, described above.

Preferred films are those supplied by Monosol under the trade references M8630, M8900, M8779, M8310, films described in U.S. Pat. No. 6,166,117 and U.S. Pat. No. 6,787,512 and PVA films of corresponding solubility and deformability characteristics. Further preferred films are those describes in US2006/0213801, WO 2010/119022, US2011/0188784 and U.S. Pat. No. 6,787,512.

Preferred water soluble films are those resins comprising one or more PVA polymers, preferably said water soluble film resin comprises a blend of PVA polymers. For example, the PVA resin can include at least two PVA polymers, wherein as used herein the first PVA polymer has a viscosity less than the second PVA polymer. A first PVA polymer can have a viscosity of at least 8 cP (cP mean centipoise), 10 cP, 12 cP, or 13 cP and at most 40 cP, 20 cP, 15 cP, or 13 cP, for example in a range of about 8 cP to about 40 cP, or 10 cP to about 20 cP, or about 10 cP to about 15 cP, or about 12 cP to about 14 cP, or 13 cP. Furthermore, a second PVA polymer can have a viscosity of at least about 10 cP, 20 cP, or 22 cP and at most about 40 cP, 30 cP, 25 cP, or 24 cP, for example in a range of about 10 cP to about 40 cP, or 20 to about 30 cP, or about 20 to about 25 cP, or about 22 to about 24, or about 23 cP, The viscosity of a PVA polymer is determined by measuring a freshly made solution using a Brookfield. LV type viscometer with UL adapter as described in British Standard EN ISO 15023-2:2006 Annex E Brookfield Test method. It is international practice to state the viscosity of 4% aqueous polyvinyl alcohol solutions at 20 .deg. C. All viscosities specified herein in cP should be understood to refer to the viscosity of 4% aqueous polyvinyl alcohol solution at 20 .deg. C., unless specified otherwise. Similarly, when a resin is described as having (or not having) a particular viscosity, unless specified otherwise, it is intended that the specified viscosity is the average viscosity for the resin, which inherently has a corresponding molecular weight distribution.

The individual PVA polymers can have any suitable degree of hydrolysis, as long as the degree of hydrolysis of the PVA resin is within the ranges described herein. Optionally, the PVA resin can, in addition or in the alternative, include a first PVA polymer that has a Mw in a range of about 50,000 to about 300,000 Daltons, or about 60,000 to about 150,000 Daltons; and a second PVA polymer that has a Mw in a range of about 60,000 to about 300,000 Daltons, or about 80,000 to about 250,000 Daltons.

The PVA resin can still further include one or more additional PVA polymers that have a viscosity in a range of about 10 to about 40 cP and a degree of hydrolysis in a range of about 84% to about 92%.

When the PVA resin includes a first PYA polymer having an average viscosity less than about 11 cP and a polydispersity index in a range of about 1.8 to about 2.3, then in one type of embodiment the PVA resin contains less than about 30 wt % of the first PVA polymer. Similarly, when the PVA resin includes a first PVA polymer having an average viscosity less than about 11 cP and a polydispersity index in a range of about 1.8 to about 2.3, then in another, non-exclusive type of embodiment the PVA resin contains less than about 30 wt. % o of a PVA polymer having a Mw less than about 70,000 Daltons.

Of the total PVA resin content in the film described herein, the PVA resin can comprise about 30 to about 85 wt. % of the first PVA polymer, or about 45 to about 55 wt. % of the first PVA polymer. For example, the PVA resin can contain about 50 wt. % of each PVA polymer, wherein the viscosity of the first PVA polymer is about 13 cP and the viscosity of the second PVA polymer is about 23 cP.

One type of embodiment is characterized by the PVA resin including about 40 to about 85 wt. % of a first PVA polymer that has a viscosity in a range of about 10 to about 15 cP and a degree of hydrolysis in a range of about 84% to about 92%. Another type of embodiment is characterized by the PVA resin including about 45 to about 55 wt. % of the first PVA polymer that has a viscosity in a range of about 10 to about 15 cP and a degree of hydrolysis in a range of about 84% to about 92%. The PVA resin can include about 15 to about 60 wt. % of the second PVA polymer that has a viscosity in a range of about 20 to about 25 cP and a degree of hydrolysis in a range of about 84% to about 92%, One contemplated class of embodiments is characterized by the PVA resin including about 45 to about 55 wt. % of the second PVA polymer.

When the PVA resin includes a plurality of PVA polymers the PDI value of the PVA resin is greater than the PDI value of any individual, included PVA polymer. Optionally, the PDI value of the PVA resin is greater than 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.5, or 5.0.

Preferably the PVA resin has a weighted, average degree of hydrolysis ( H̅°̅) between about 80 and about 92%, or between about 83 and about 90%, or about 85 and 89%. For example, H̅°̅ for a PVA resin that comprises two or more PVA polymers is calculated by the formula H̅°̅=Σ(Wi·Hᵢ) where Wᵢ is the weight percentage of the respective PVA polymer and a Hᵢ is the respective degrees of hydrolysis. Still further it is desirable to choose a PVA resin that has a weighted log viscosity ( μ̅) between about 10 and about 25, or between about 12 and 22, or between about 13.5 and about 20. The μ̅ for a PVA resin that comprises two or more PVA polymers is calculated by the formula μ̅=e^{ΣW}^{ᵢ}^{·ln μ}^{ᵢ} where μᵢ is the viscosity for the respective PVA polymers.

Yet further, it is desirable to choose a PVA resin that has a Resin Selection Index (RSI) in a range of 0.255 to 0.315, or 0.260 to 0.310, or 0.265 to 0.305, or 0.270 to 0.300, or 0.275 to 0.295, preferably 0.270 to 0.300. The RSI is calculated by the formula; Σ(Wᵢ|μᵢ−μₜ|)/Σ(Wᵢμᵢ), wherein μₜ is seventeen, μᵢ is the average viscosity each of the respective PVOII polymers, and Wᵢ is the weight percentage of the respective PVOII polymers. The anionic group of G is preferably selected from the group consisting of OSO₃M, SO₃M, CO₂M, OCO₂M, OPO₃M₂, OPO₃HM and OPO₂M. More preferably anionic group of G is selected from the group consisting of OSO₃M, SO₃M, CO₂M, and OCO₂M. Most preferably the anionic group of G is selected from the group consisting of SO₃M and CO₂M.

Naturally, different film material and/or films of different thickness may be employed in making the compartments of the present invention. A benefit in selecting different films is that the resulting compartments may exhibit different solubility or release characteristics.

The film material herein can also comprise one or more additive ingredients. For example, it can be beneficial to add plasticisers, for example glycerol, ethylene glycol, diethyleneglycol, propylene glycol, sorbitol and mixtures thereof. Other additives may include water and functional detergent additives, including water, to be delivered to the wash water, for example organic polymeric dispersants, etc.

The film may be opaque, transparent or translucent. The film may comprise a printed area. The printed area may cover between 10 and 80% of the surface of the film; or between 10 and 80% of the surface of the film that is in contact with the internal space of the compartment; or between 10 and 80% of the surface of the film and between 10 and 80% of the surface of the compartment.

The area of print may cover an uninterrupted portion of the film or it may cover parts thereof, i.e. comprise smaller areas of print, the sum of which represents between 10 and 80% of the surface of the film or the surface of the film in contact with the internal space of the compartment or both.

The area of print may comprise inks, pigments, dyes, blueing agents or mixtures thereof. The area of print may be opaque, translucent or transparent.

The area of print may comprise a single colour or maybe comprise multiple colours, even three colours. The area of print may comprise white, black, blue, red colours, or a mixture thereof. The print may be present as a layer on the surface of the film or may at least partially penetrate into the film. The film will comprise a first side and a second side. The area of print may be present on either side of the film, or be present on both sides of the film. Alternatively, the area of print may be at least partially comprised within the film itself.

The area of print may comprise an ink, wherein the ink comprises a pigment. The ink for printing onto the film has preferably a desired dispersion grade in water. The ink may be of any color including white, red, and black. The ink may be a water-based ink comprising from 10% to 80% or from 20% to 60% or from 25% to 45% per weight of water. The ink may comprise from 20% to 90% or from 40% to 80% or from 50% to 75% per weight of solid.

The ink may have a viscosity measured at 20° C. with a shear rate of 1000s⁻¹ between 1 and 600 cPs or between 50 and 350 cPs or between 100 and 300 cPs or between 150 and 250 cPs. The measurement may be obtained with a cone-plate geometry on a TA instruments AR-550 Rheometer.

The area of print may be achieved using standard techniques, such as flexographic printing or inkjet printing. Preferably, the area of print is achieved via flexographic printing, in which a film is printed, then moulded into the shape of an open compartment. This compartment is then filled with a detergent composition and a second film placed over the compartment and sealed to the first film. The area of print may be on either or both sides of the film.

Alternatively, an ink or pigment may be added during the manufacture of the film such that all or at least part of the film is coloured.

The film may comprise an aversive agent, for example a bittering agent. Suitable bittering agents include, but are not limited to, naringin, sucrose octaacetate, quinine hydrochloride, denatonium benzoate, or mixtures thereof. Any suitable level of aversive agent may be used in the film. Suitable levels include, but are not limited to, 1 to 5000 ppm, or even 100 to 2500 ppm, or even 250 to 2000 rpm.

### Cleaning Composition

The composition 40 may be any suitable composition. The composition may be in the form of a solid, a liquid, a dispersion, a gel, a paste, a slurry or a mixture thereof. The composition may be in the form of a liquid, a powder, or a combination thereof. Non-limiting examples of compositions include cleaning compositions, fabric care compositions and hard surface cleaners. More particularly, the compositions may be a laundry, fabric care or dish washing composition including, pre-treatment or soaking compositions and other rinse additive compositions. The cleaning composition may be selected from a fabric cleaning composition, an automatic dishwashing composition, a hard surface cleaning composition of a mixture thereof. The composition may be a fabric detergent composition or an automatic dish washing composition. The fabric detergent composition may be used during the main wash process or could be used as pre-treatment or soaking compositions.

Fabric care compositions include fabric detergents, fabric softeners, 2-in-1 detergent and softening, pre-treatment compositions and the like. Fabric care compositions comprise typical fabric care compositions, including surfactants, builders, chelating agents, dye transfer inhibiting agents, dispersants, enzymes, and enzyme stabilizers, catalytic materials, bleach activators, polymeric dispersing agents, clay soil removal/anti-redeposition agents, brighteners, suds suppressors, dyes, additional perfume and perfume delivery systems, structure elasticizing agents, fabric softeners, carriers, hydrotropes, processing aids and/or pigments and mixtures thereof. The composition may be a laundry detergent composition comprising an ingredient selected from the group comprising a shading dye, surfactant, polymers, perfumes, encapsulated perfume materials, structurant and mixtures thereof.

The composition may be an automatic dish washing composition comprising an ingredient selected from surfactant, builder, sulfonated/carboxylated polymer, silicone suds suppressor, silicate, metal and/or glass care agent, enzyme, bleach, bleach activator, bleach catalyst, source of alkalinity, perfume, dye, solvent, filler and mixtures thereof.

Surfactants can be selected from anionic, cationic, zwitterionic, non-ionic, amphoteric or mixtures thereof. Preferably, the fabric care composition comprises anionic, non-ionic or mixtures thereof.

The anionic surfactant may be selected from linear alkyl benzene sulfonate, alkyl ethoxylate sulphate and combinations thereof.

Suitable anionic surfactants useful herein can comprise any of the conventional anionic surfactant types typically used in liquid detergent products. These include the alkyl benzene sulfonic acids and their salts as well as alkoxylated or non-alkoxylated alkyl sulfate materials.

Suitable nonionic surfactants for use herein include the alcohol alkoxylate nonionic surfactants. Alcohol alkoxylates are materials which correspond to the general formula: R¹(CₘH₂ₘO)ₙOH wherein R¹ is a C₈-C₁₆ alkyl group, m is from 2 to 4, and n ranges from about 2 to 12. In one aspect, R¹ is an alkyl group, which may be primary or secondary, that comprises from about 9 to 15 carbon atoms, or from about 10 to 14 carbon atoms. In one aspect, the alkoxylated fatty alcohols will also be ethoxylated materials that contain from about 2 to 12 ethylene oxide moieties per molecule, or from about 3 to 10 ethylene oxide moieties per molecule.

The shading dyes employed in the present laundry care compositions may comprise polymeric or non-polymeric dyes, pigments, or mixtures thereof. Preferably the shading dye comprises a polymeric dye, comprising a chromophore constituent and a polymeric constituent. The chromophore constituent is characterized in that it absorbs light in the wavelength range of blue, red, violet, purple, or combinations thereof upon exposure to light. In one aspect, the chromophore constituent exhibits an absorbance spectrum maximum from about 520 nanometers to about 640 nanometers in water and/or methanol, and in another aspect, from about 560 nanometers to about 610 nanometers in water and/or methanol.

Although any suitable chromophore may be used, the dye chromophore is preferably selected from benzodifuranes, methine, triphenylmethanes, napthalimides, pyrazole, napthoquinone, anthraquinone, azo, oxazine, azine, xanthene, triphenodioxazine and phthalocyanine dye chromophores. Mono and di-azo dye chromophores are preferred.

The shading dye may comprise a dye polymer comprising a chromophore covalently bound to one or more of at least three consecutive repeat units. It should be understood that the repeat units themselves do not need to comprise a chromophore. The dye polymer may comprise at least 5, or at least 10, or even at least 20 consecutive repeat units.

The repeat unit can be derived from an organic ester such as phenyl dicarboxylate in combination with an oxyalkyleneoxy and a polyoxyalkyleneoxy. Repeat units can be derived from alkenes, epoxides, aziridine, carbohydrate including the units that comprise modified celluloses such as hydroxyalkylcellulose; hydroxypropyl cellulose; hydroxypropyl methylcellulose; hydroxybutyl cellulose; and, hydroxybutyl methylcellulose or mixtures thereof. The repeat units may be derived from alkenes, or epoxides or mixtures thereof. The repeat units may be C2-C4 alkyleneoxy groups, sometimes called alkoxy groups, preferably derived from C2-C4 alkylene oxide. The repeat units may be C2-C4 alkoxy groups, preferably ethoxy groups.

For the purposes of the present invention, the at least three consecutive repeat units form a polymeric constituent. The polymeric constituent may be covalently bound to the chromophore group, directly or indirectly via a linking group. Examples of suitable polymeric constituents include polyoxyalkylene chains having multiple repeating units. In one aspect, the polymeric constituents include polyoxyalkylene chains having from 2 to about 30 repeating units, from 2 to about 20 repeating units, from 2 to about 10 repeating units or even from about 3 or 4 to about 6 repeating units. Non-limiting examples of polyoxyalkylene chains include ethylene oxide, propylene oxide, glycidol oxide, butylene oxide and mixtures thereof.

The dye may be introduced into the detergent composition in the form of the unpurified mixture that is the direct result of an organic synthesis route. In addition to the dye polymer therefore, there may also be present minor amounts of un-reacted starting materials, products of side reactions and mixtures of the dye polymers comprising different chain lengths of the repeating units, as would be expected to result from any polymerisation step.

The compositions can comprise one or more detergent enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination is a cocktail of conventional applicable enzymes like protease, lipase, cutinase and/or cellulase in conjunction with amylase.

The fabric care compositions of the present invention may comprise one or more bleaching agents. Suitable bleaching agents other than bleaching catalysts include photobleaches, bleach activators, hydrogen peroxide, sources of hydrogen peroxide, pre-formed peracids and mixtures thereof. In general, when a bleaching agent is used, the compositions of the present invention may comprise from about 0.1% to about 50% or even from about 0.1% to about 25% bleaching agent by weight of the subject cleaning composition.

The composition may comprise a brightener. Suitable brighteners are stilbenes, such as brightener 15. Other suitable brighteners are hydrophobic brighteners, and brightener 49. The brightener may be in micronized particulate form, having a weight average particle size in the range of from 3 to 30 micrometers, or from 3 micrometers to 20 micrometers, or from 3 to 10 micrometers. The brightener can be alpha or beta crystalline form.

The compositions herein may also optionally contain one or more copper, iron and/or manganese chelating agents. If utilized, chelating agents will generally comprise from about 0.1% by weight of the compositions herein to about 15%, or even from about 3.0% to about 15% by weight of the compositions herein.

The composition may comprise a calcium carbonate crystal growth inhibitor, such as one selected from the group consisting of: 1-hydroxyethanediphosphonic acid (HEDP) and salts thereof; N,N-dicarboxymethyl-2-aminopentane-1,5-dioic acid and salts thereof; 2-phosphonobutane-1,2,4-tricarboxylic acid and salts thereof; and any combination thereof.

The compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in the compositions herein, the dye transfer inhibiting agents are present at levels from about 0.0001%, from about 0.01%, from about 0.05% by weight of the cleaning compositions to about 10%, about 2%, or even about 1% by weight of the cleaning compositions.

The fabric care composition may comprise one or more polymers. Suitable polymers include carboxylate polymers, polyethylene glycol polymers, polyester soil release polymers such as terephthalate polymers, amine polymers, cellulosic polymers, dye transfer inhibition polymers, dye lock polymers such as a condensation oligomer produced by condensation of imidazole and epichlorhydrin, optionally in ratio of 1:4:1, hexamethylenediamine derivative polymers, and any combination thereof.

Other suitable cellulosic polymers may have a degree of substitution (DS) of from 0.01 to 0.99 and a degree of blockiness (DB) such that either DS+DB is of at least 1.00 or DB+2DS-DS² is at least 1.20. The substituted cellulosic polymer can have a degree of substitution (DS) of at least 0.55. The substituted cellulosic polymer can have a degree of blockiness (DB) of at least 0.35. The substituted cellulosic polymer can have a DS+DB, of from 1.05 to 2.00. A suitable substituted cellulosic polymer is carboxymethylcellulose.

Another suitable cellulosic polymer is cationically modified hydroxyethyl cellulose.

Suitable perfumes include perfume microcapsules, polymer assisted perfume delivery systems including Schiff base perfume/polymer complexes, starch-encapsulated perfume accords, perfume-loaded zeolites, blooming perfume accords, and any combination thereof. A suitable perfume microcapsule is melamine formaldehyde based, typically comprising perfume that is encapsulated by a shell comprising melamine formaldehyde. It may be highly suitable for such perfume microcapsules to comprise cationic and/or cationic precursor material in the shell, such as polyvinyl formamide (PVF) and/or cationically modified hydroxyethyl cellulose (catIIEC).

Suitable suds suppressors include silicone and/or fatty acid such as stearic acid.

### Method of Making the Water-Soluble Article

The process may be continuous or intermittent. The process comprises the general steps of forming an open pouch, preferably by forming a water-soluble film into a mould to form said open pouch, filling the open pouch with a composition, closing the open pouch filled with a composition, preferably using a second water-soluble film to form the article. The second film may also comprise compartments, which may or may not comprise compositions. Alternatively, the second film may be a second closed pouch containing one or more compartments, used to close the open pouch. Preferably, the process is one in which a web of articles are made, said web is then cut to form individual articles.

The article may be made by thermoforming, vacuum-forming or a combination thereof. Articles may be sealed using any sealing method known in the art. Suitable sealing methods may include heat sealing, solvent sealing, pressure sealing, ultrasonic sealing, pressure sealing, laser sealing or a combination thereof.

The articles may be dusted with a dusting agent. Dusting agents can include talc, silica, zeolite, carbonate or mixtures thereof.

An exemplary means of making the article of the present invention is a continuous process for making an article according to any preceding claims, comprising the steps of:
a. continuously feeding a first water-soluble film onto a horizontal portion of an continuously and rotatably moving endless surface, which comprises a plurality of moulds, or onto a non-horizontal portion thereof and continuously moving the film to said horizontal portion;
b. forming from the film on the horizontal portion of the continuously moving surface, and in the moulds on the surface, a continuously moving, horizontally positioned web of open pouches;
c. filling the continuously moving, horizontally positioned web of open pouches with a product, to obtain a horizontally positioned web of open, filled pouches;
d. preferably continuously, closing the web of open pouches, to obtain closed pouches, preferably by feeding a second water-soluble film onto the horizontally positioned web of open, filed pouches, to obtain closed pouches; and
e. optionally sealing the closed pouches to obtain a web of closed pouches.

The second water-soluble film may comprise at least one open or closed compartment.

In one embodiment, a first web of open pouches is combined with a second web of closed pouches preferably wherein the first and second webs are brought together and sealed together via a suitable means, and preferably wherein the second web is a rotating drum set-up. In such a set-up, pouches are filled at the top of the drum and preferably sealed afterwards with a layer of film, the closed pouches come down to meet the first web of pouches, preferably open pouches, formed preferably on a horizontal forming surface. It has been found especially suitable to place the rotating drum unit above the horizontal forming surface unit.

Preferably, the resultant web of closed pouches are cut to produce individual articles.

Those skilled in the art would recognize the appropriate size of mould needed in order to make an article according to the present invention.

### Process to Make the Cleaning Product

Any suitable process known to those skilled in the art may be used to make the cleaning product of the present invention. The process may be continuous or intermittent.

The process may comprise the step of packaging the article of the present invention in the external film via horizontal flow wrapping, vertical form fill sealing, horizontal form fill sealing or a combination thereof.

Preferably, the process comprises the steps of forming a preformed or shaped external film comprising an opening, placing the article into the preformed or shaped film though the opening via dropping by gravity or mechanical insertion, and then sealing the film opening closed.

Alternatively, the film may be wrapped around the article and then sealed. Those skilled in the art will be aware of suitable sealing means. The external flexible film may be sealed via heat sealing, pressure sealing, adhesive, heat activated adhesive, pressure activated adhesive or a combination thereof. The external flexible film could be sealed in such a way that the cleaning product comprises only one seal, or at least two seals, or even at least three seals. The flexible external film could be shaped such that the cleaning product comprises two seals orientated at opposite ends of the product. Alternatively, it could be shaped such that the product comprises one seal running along the length of the product. Alternatively, the film could be shaped such that the product comprises three seals in which one runs the length of the product and there are two further seals orientated at opposite end of the product.

### Method of Using the Cleaning Product

The method comprises the steps of releasing the flexible water-soluble article from the internal chamber by rupturing the external flexible water-insoluble film. The article can then be added the drum of internal space of an automatic washing machine. Alternatively it may be added to the drum of an automatic washing machine. Alternatively, it may be added to a wash liquor. Alternatively it may be added directly to a stain or soiled area.

The wash liquor may be at any suitable temperature, preferably from 10° to 90° C. or even from 15° C. to 60° C. The wash liquor may be present in one or more wash cycles of an automatic wash operation.

### Package

The present invention is also to a package comprising at least one cleaning product according to the present invention. The package may comprise at least two, or even at least five, or even at least ten cleaning products.

The package may be rigid, flexible or a combination thereof. The package comprises a resealable opening.

The package may be a rigid tub comprising a recloseable lid. The recloseable lid may comprise a latch. The opening may comprise child resistant means, i.e. comprise means to make it difficult for a child to open said package.

Where a package is present, the user may select one or more cleaning products from the package and then use them as detailed above.

### EXAMPLES

An exemplary cleaning product according to the present invention comprises an external flexible water-insoluble film defining an internal chamber. The external flexible film comprises a plastic material. Contained within the internal chamber is a flexible water-soluble article. The water-soluble article comprises three water-soluble polyvinyl alcohol films defining three internal compartments, wherein the compartments are arranged in a superposed orientation. Two compartments are arranged side-by-side and are superposed onto the third compartment. The article comprises a liquid fabric cleaning composition.

Another exemplary cleaning product according to the present invention comprises an external flexible water-insoluble film defining an internal chamber. The external flexible film comprises a plastic material and wherein the external flexible film comprises holes such as to be in the form of a net. Contained within the internal chamber is a flexible water-soluble article. The water-soluble article comprises three water-soluble polyvinyl alcohol films defining three internal compartments, wherein the compartments are arranged in a superposed orientation. Two compartments are arranged side-by-side and are superposed onto the third compartment. The article comprises a liquid fabric cleaning composition.

Yet another exemplary cleaning product according to the present invention comprises an external flexible water-insoluble film defining an internal chamber. The external flexible film comprises a plastic material and wherein the external flexible film comprises an area of print. Contained within the internal chamber is a flexible water-soluble article. The water-soluble article comprises three water-soluble polyvinyl alcohol films defining three internal compartments, wherein the compartments are arranged in a superposed orientation. Two compartments are arranged side-by-side and are superposed onto the third compartment. The article comprises a liquid fabric cleaning composition.

A further exemplary cleaning product according to the present invention comprises an external flexible water-insoluble film defining an internal chamber. The external flexible film comprises a plastic material and wherein the external flexible film comprises an area of weakness to assist in opening the external film. Contained within the internal chamber is a flexible water-soluble article. The water-soluble article comprises three water-soluble polyvinyl alcohol films defining three internal compartments, wherein the compartments are arranged in a superposed orientation. Two compartments are arranged side-by-side and are superposed onto the third compartment. The article comprises a liquid fabric cleaning composition.

Further exemplary cleaning products include all the above cleaning products wherein the flexible article comprises an area of print. An exemplary cleaning product includes all the above cleaning products wherein the flexible article comprises an area of print printed on the inside of the water-soluble film such that the area of print is in contact with the internal composition of the article.

Yet another exemplary cleaning product includes all the above cleaning products wherein the flexible article comprises an aversive agent present in the water-soluble film; a particular example is wherein the aversive agent is denatonium benzoate, present at a level of from 1 ppm to 5000 ppm.

A further exemplary cleaning product includes all the above cleaning products wherein the flexible article comprises an area of print and the flexible article comprises an aversive agent present in the water-soluble film; a particular example is wherein the flexible article comprises an area of print printed on the inside of the water-soluble film such that the area of print is in contact with the internal composition of the article and the aversive agent is denatonium benzoate, present at a level of from 1 ppm to 5000 ppm.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A cleaning product comprising;
a. an external flexible water-insoluble film defining an internal chamber;
b. at least one flexible water-soluble article contained within the internal chamber, wherein the article comprises a cleaning composition;
wherein, the volume of the internal chamber is no greater than about 15% larger than the volume of the article.

2. The product according to claim 1, wherein the external film is sealed so that the article cannot be removed from the internal chamber without rupturing the external film.

3. The product according to claim 2, wherein the external film is sealed via heat sealing, pressure sealing, cold adhesive, heat activated adhesive, pressure activated adhesive, ultrasonic sealing or a combination thereof.

4. The product according to claim 1, wherein the cleaning composition is a solid, a liquid, a dispersion, a gel, a paste, a slurry or a mixture thereof.

5. The product according to claim 1, wherein the article comprises a water-soluble film defining at least one internal compartment, wherein the cleaning composition is contained within said compartment.

6. The product according to claim 5, wherein the article comprises at least two compartments.

7. The product according to claim 1, wherein the cleaning composition is selected from a fabric cleaning composition, an automatic dishwashing composition, a hard surface cleaning composition or a mixture thereof.

8. The product according to claim 1, wherein the internal chamber is no greater than about 10% larger than the volume of the article.

9. The product according to claim 8, wherein the internal chamber is no greater than about 5% larger than the volume of the article.

10. The product according to claim 1, wherein the external film is made from non-woven materials, woven materials or mixtures thereof.

11. The product according to claim 1, wherein the external film comprises holes or gaps.

12. The product according to claim 11, wherein the external film is in the form of a net or web.

13. The product according to claim 1, wherein the external film comprises a plastic material, a metallic material or a combination thereof.

14. The product according to claim 13, wherein the external film comprises polyethylene, polypropylene, polyethylene terephthalate, aliphatic polyamides, aluminium, paper or a combination thereof.

15. The product according to claim 1, wherein the external film is a monolayer film or a laminate film.

16. The product according to claim 1, wherein the external film comprises an area of print.

17. The product according to claim 1, wherein the water-soluble film comprises an area of print.

18. A process for making a packaged product according to claim 1, comprising the step of packaging the article in the external film via horizontal flow wrapping, vertical form fill sealing, horizontal form fill sealing or a combination thereof.

19. The process according to claim 18 comprising the steps of forming a preformed or shaped external film comprising an opening, placing the article into the preformed or shaped film though the opening via dropping by gravity or mechanical insertion, and sealing the film opening closed, or comprising the step of forming the external film around the article and sealing the film closed.

20. A package comprising at least one product according to claim 1, wherein the package is rigid, flexible, or a combination thereof and comprises a resealable opening.
